(19) United States
(12) Patent Application Publication
(10) Pub. No.: US 2025/0117723 A1
(43) Pub. Date: Apr. 10, 2025

(54) METHOD AND SYSTEM FOR COURSE ASSESSMENT IN A LEARNING MANAGEMENT SYSTEM

(71) Applicant: D2L Corporation, Kitchener (CA)

(72) Inventor: Jeremy AUGER, Kitchener (CA)

(21) Appl. No.: 18/910,663

(22) Filed: Oct. 9, 2024

Related U.S. Application Data
(60) Provisional application No. 63/589,164, filed on Oct. 10, 2023.

(51) Int. Cl. G06Q 10/0631; G06Q 10/0639

(52) U.S. Cl. CPC G06Q 10/063112; G06Q 10/063114; G06Q 10/06398

(57) ABSTRACT

A method and system for course assessment. The method includes: monitoring for a request to select assessors for a course by an instructor; upon receipt of a request, preparing a list of potential assessors and determining if additional potential assessors are required, if so: automatically posting a request for potential assessors; and receiving information about potential assessors; and updating the list of potential assessors; if not: proceeding; selecting assessors for the course from the list of potential assessors; assigning the select assessors to a set of students in the course, and monitoring the assigned assessors during and after the course. In some cases, the list of potential assessors is displayed to allow the instructor to select or assist with selection of the assessors. The system includes a processor and various modules configured to perform the method.

### FIELD

The present disclosure relates generally to course assessment in a learning management system. More particularly, the present disclosure relates to a method and system for distributed course assessment of large scale courses.

### BACKGROUND

Learning management systems (“LMS”) are becoming more popular for delivery of educational material in many different situations, whether in conventional areas like public/private educational institutions all the way through to corporations providing internal training to their employees. Some LMSs merely track student registration and progress while others deliver course content and materials directly to students.

With the rapid increase of LMSs and the organizations that use them and provide educational content, there is also an increase in the number of students that may be taking a particular course. In some cases, the number of students may be in the tens of thousands of students. In such large classes, it can be difficult for an instructor to provide an assessment for each student in an efficient, fair and effective manner. While instructors have traditionally used teaching assistants, multiple choice (computer graded) testing, and the like, these techniques can have problems in relation to consistency, true assessment of capability, and the like. As such, there is a need for an improved system and method for assessment at scale in a learning management system.

The above information is presented as background information only to assist with an understanding of the present disclosure. No determination has been made, and no assertion is made, as to whether any of the above might be applicable as prior art with regard to the present disclosure.

### SUMMARY

In a first aspect, there is provided a method for course assessment, the method including: monitoring for a request to select assessors for a course by an instructor; upon receipt of a request, preparing a list of potential assessors and determining if additional potential assessors are required, if so: automatically posting a request for potential assessors; and receiving information about potential assessors; and updating the list of potential assessors; if not: proceeding; selecting assessors for the course from the list of potential assessors; assigning the select assessors to a set of students in the course, and monitoring the assigned assessors during and after the course.

In some cases, the method may further include, prior to selecting assessors, displaying the list of potential assessors to the instructor.

In some cases, the displaying the list of potential assessors may include presenting one or more informational elements for each assessor. In this case, the one or more informational elements for each assessor may include, if available, past evaluations for each assessor.

In some cases, the displaying the list of potential assessors may include: presenting a first informational element for assessors that are already approved; and presenting a second informational element for assessors that require additional information before registration.

In some cases, the assigning the select assessors to the course may include at least one of: sending a communication to the accessor notifying of the assignment; and providing login information to the assessor.

In some cases, the assigning the select assessors to a set of students in the course further may include: updating the assignment of the assessors to a different set of students during the course. The updating may also include assigning new assessors.

In some cases, the monitoring the assigned assessors may include: collecting evaluations for the assigned assessors; and storing the collected evaluations in association with the assigned assessors.

In some cases, the determining if additional potential assessors are required may include: determining if the instructor has requested additional instructors, and if not, determining if there are sufficient assessors on the list of potential assessors.

According to another aspect herein, there is provided a system for course assessment, the system including: a processor; a memory storing computer-readable instructions, which, when executed on the processor, generate the following: an assessor management module configured to: monitor for a request to select assessors for a course by an instructor; upon receipt of a request, preparing a list of potential assessors and determine if additional potential assessors are required, if so: automatically posting a request for potential assessors; and receiving information about potential assessors; and updating the list of potential assessors; if not: proceeding; select assessors for the course from the list of potential assessors; and an assessment management module configured to: assign the select assessors to a set of students in the course, and monitor the assigned assessors during and after the course.

In some cases, the assessor management module, prior to the select assessors, displays the list of potential assessors to the instructor. In this way, the instructor can participate in the selection of accessors, either as the sole selector or in conjunction with the system. If displaying assessors, the displaying the list of potential assessors may include presenting one or more informational elements for each assessor. In this case, the one or more informational elements for each assessor may include, if available, past evaluations for each assessor.

In some cases, the displaying the list of potential assessors may include: presenting a first informational element for assessors that are already approved; and presenting a second informational element for assessors that require additional information before registration.

In some cases, the assign the select assessors may include at least one of: sending a communication to the accessor notifying of the assignment; and providing login information to the assessor.

In some cases, the assign the select assessors further may include: updating the assignment of the assessors to a different set of students during the course.

In some cases, the monitor the assigned assessors may include: collecting evaluations for the assigned assessors; and storing the collected evaluations in association with the assigned assessors.

In some cases, the determine if additional potential assessors are required may include: determining if the instructor has requested additional instructors, and if not, determining if there are sufficient assessors on the list of potential assessors. Other aspects and features of the present disclosure will become apparent to those ordinarily skilled in the art upon review of the following description of specific embodiments in conjunction with the accompanying figures.

### BRIEF DESCRIPTION OF FIGURES

Embodiments of the present disclosure will now be described, by way of example only, with reference to the attached Figures.

FIG. 1 illustrates an example of a learning management system;

FIG. 2 illustrates an example of a computing device for communication with the learning management system of FIG. 1;

FIG. 3 illustrates an example of a course assessment module according to an embodiment herein;

FIG. 4 illustrates an example of an assessor management module according to an embodiment herein;

FIG. 5 illustrates an example display by a course assessment module according to an embodiment herein; and

FIG. 6 is a flowchart illustrating a method for course assessment according to an embodiment herein.

### DETAILED DESCRIPTION

The following description with reference to the accompanying drawings is provided to assist in a comprehensive understanding of example embodiments as defined by the claims and their equivalents. The following description includes various specific details to assist in that understanding but these are to be regarded as merely examples. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not intended to be limited to the bibliographical meanings, but, are merely used by the inventor to enable a clear and consistent understanding. Accordingly, it should be apparent to those skilled in the art that the following description of embodiments is provided for illustration purpose only and not for the purpose of limiting the invention as defined by the appended claims and their equivalents.

Generally, the present disclosure provides a method and system for course registration. In particular, the embodiments of the system and method detailed herein provide for a method and system for course registration that includes access to promotional material, checking of pre-requisites/approval, and immediate registration for those with pre-requisites/approval.

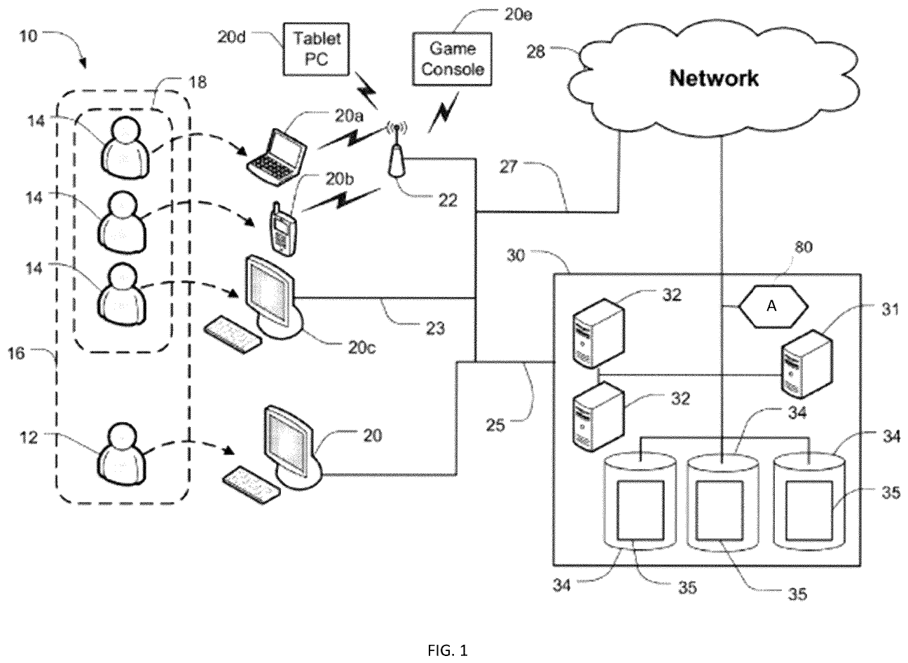

FIG. 1 illustrates an example embodiment of a learning management system 10 according to one embodiment. The learning management system 10 includes an educational service provider system 30, which can be accessed by various users 12, 14 via computer networks.

The users 12, 14 communicate with the educational service provider system 30 either directly or indirectly using any suitable computing device 20, such as, for example a desktop computer that has at least one input device (e.g., a keyboard and a mouse) and at least one output device (e.g., a display screen and speakers). Other examples of the computing device may include: a laptop 20a wirelessly coupled to an access point 22 (e.g., a wireless router, a cellular communications tower, etc.), a wirelessly enabled mobile device, smart phone or the like 20b, a terminal 20c over a wired connection 23, a tablet computer 20d, or a game console 20e over a wireless connection. The computing devices 20 may be connected to the educational service provider system 30 via any suitable communications channel. For example, the computing devices 20 may communicate to the educational service provider system 30 directly through a LAN/intranet or wireless network via a data connection 25, or using an external network, such as, for example, the Internet 28 over a data connection 27.

In some cases, one or more of the users 12 and 14 may be required to authenticate their identities in order to communicate with the educational service provider system 30. For example, the users 12 and 14 may be required to input a login name and/or a password or otherwise identify themselves to gain access to the learning management system 10. In other cases, one or more users (e.g., “guest” users) may be able to access the learning management system 10 without authentication. Such guest users may be provided with limited access, such as the ability to review only one or a few components of the course, for example, to decide whether they would like to enroll in a particular course.

The educational service provider system 30 generally includes a number of components for facilitating the provision of electronic learning services. For example, the educational service provider system 30 generally includes one or more processing devices 32 (e.g., servers), each having one or more processors. The processing devices 32 are configured to send information (e.g., HTML or other data) to be displayed on one or more computing devices 20, 20a, 20b and/or 20c to facilitate social electronic learning (e.g., course information). In some cases, the processing device 32 may be a computing device 20 (e.g., a laptop or a personal computer).

The educational service provider system 30 also generally includes one or more data storage devices 34 (e.g., memory, etc.) that are in communication with the processing devices 32, and could include a relational database (such as an SQL database), or other suitable data storage devices. The data storage devices 34 are configured to host data 35 relating to the courses offered by the service provider.

For example, the data 35 can include course frameworks, educational materials to be consumed by the users 14, historical records about assessments or grades of users 14 or assignments completed by the users 14, as well as various other information.

The data storage devices 34 may also store authorization criteria that define which actions may be taken by the users 12 and 14. In some cases, the authorization criteria may include at least one security profile associated with at least one role. For example, one role could be defined for users who are primarily responsible for developing an educational course, teaching it, and assessing work product from students of the course. Users with such a role may have a security profile that allows them to configure various components of the course, to post assignments, to add assessments, to evaluate performance, and so on.

In some cases, some of the authorization criteria may be defined by specific users 40 who may or may not be part of the educational community 16. For example, users 40 may be permitted to administer and/or define global configuration profiles for the learning management system 10, define roles within the learning management system 10, set security profiles associated with the roles, and assign roles to particular users 12, 14 who use the learning management system 10. In some cases, the users 40 may use another computing device (e.g., a desktop computer 42) to accomplish these tasks.

The data storage devices 34 may also be configured to store other information, such as personal information about the users 12, 14 of the learning management system 10, information about which courses the users 14 are enrolled in, roles to which the users 12 and 14 are assigned, particular interests of the users 12, 14, and historical information about the performance of the users 12, 14.

The processing devices 32 and data storage devices 34 may also provide other electronic learning management tools (e.g., allowing users to add and drop courses, communicate with other users using chat software, etc.), and/or may be in communication with one or more other vendors that provide various tools.

In some cases, the educational service provider system 30 may also have one or more backup servers 31 that may duplicate some or all of the data 35 stored on the data storage devices 34. The backup servers 31 may be desirable for disaster recovery to prevent undesired data loss in the event of an electrical outage, fire, flood or theft, for example. The backup servers 31 could be located at a remote storage location and the service provider system 30 could connect to the backup server 31 using a secure communications protocol to ensure that the confidentiality of the data 35 is maintained.

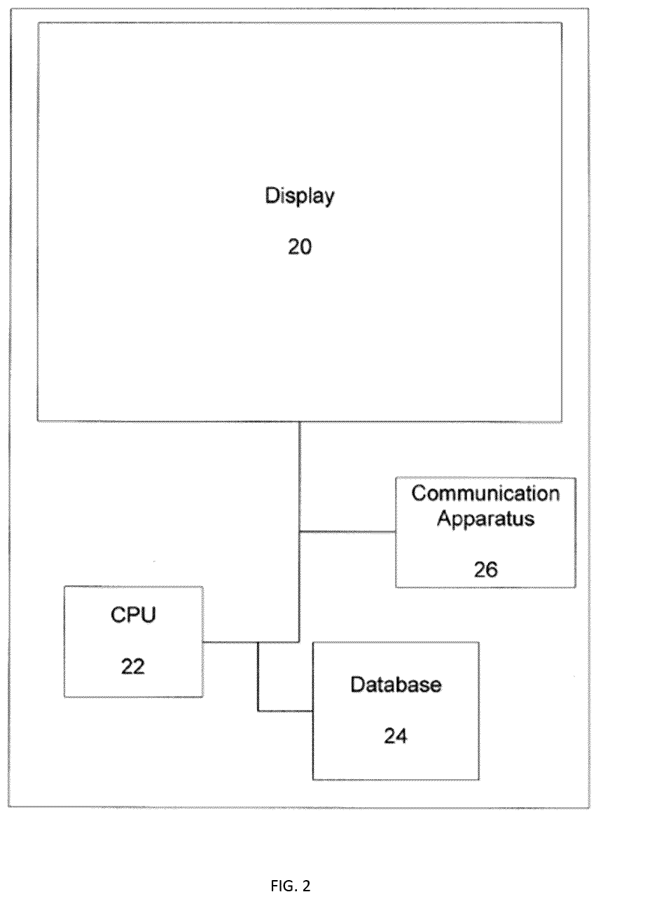

FIG. 2 is a schematic diagram of an example computing device 20, in this case, a mobile computing device, which communicates wirelessly. As shown, the computing device 20 comprises a processor 22, a memory 24, a communication apparatus 26, a display 28, and an input apparatus 29. A user 12, 14, uses the functions of the computing device 20 to communicate with the educational service provider system 30 as described herein.

Generally speaking, the users 12, 14 can use the learning management system 10 to communicate with the educational service provider system 30 to participate in, create, and consume electronic learning services, including enrolling in and participating in various educational courses. In some cases, the educational service provider system 30 may be part of or associated with a traditional “bricks and mortar” educational institution (e.g., an elementary school, a high school, a university or a college), another entity that provides educational services (e.g., an online university, a company that specializes in offering training courses, or an organization that has a training department), or an independent service provider (e.g., for providing individual electronic learning).

It should be understood that a “course” is not necessarily limited to formal courses offered by formal educational institutions. The course may generally include any form of learning instruction offered by an entity of any type. For example, the course may be a training seminar at a company for a small group of employees, a professional certification program with a larger number of intended participants (e.g., PMP, CMA, etc.), and so on.

It should also be understood that users 12, 14 may fall into various categories, including students, instructors, guests, or the like. Further, one or more educational groups can be defined that involve one or more of the users 12, 14. For example, as shown in FIG. 1, the users 12, 14 may be grouped together in an educational group 16 representative of a particular course (e.g., History 101, French 254), in which the first user 12 is an “instructor” and is responsible for providing the course (e.g., organizing lectures, preparing assignments, creating educational content, etc.), while the other users 14 are “learners” or “students” that consume the course content (e.g., the users 14 are enrolled in the course to learn the course content). In some cases, the users 12, 14 may be associated with more than one educational group. For instance, the users 14 may be enrolled in more than one course, while the user 12 may be enrolled in a course and also responsible for teaching a course (which is common for example for graduate students).

In some cases, educational sub-groups may also be defined. For example, in FIG. 1, some users 14 are shown as part of an educational sub-group 18. The sub-group 18 may be defined in relation to a particular project or assignment (e.g., sub-group 18 may be a lab group) or based on other criteria. In some cases, due to the nature of electronic learning, the users 14 in a particular sub-group 18 need not physically meet but may collaborate together using various tools provided by the educational service provider system 30.

In some cases, the groups 16 and sub-groups 18 could include users 12, 14 that share common interests (e.g., interests in a particular sport), that participate in common activities (e.g., users that are members of a choir or a club), and/or have similar attributes (e.g. users that are male, users under twenty-one years of age, etc.).

As shown in FIG. 1, the educational service provider system 30 can include a course assessment module 80, which allows for an instructor to divide assignments among a group of assessors, manage the assessors, manage the assessments, and the like. The course assessment module is expected to be particularly useful in classes with thousands of students, such as 3000, 5000, 10000 or the like. The course assessment module 80 may also be remote from but connectable with the educational service provider system 30.

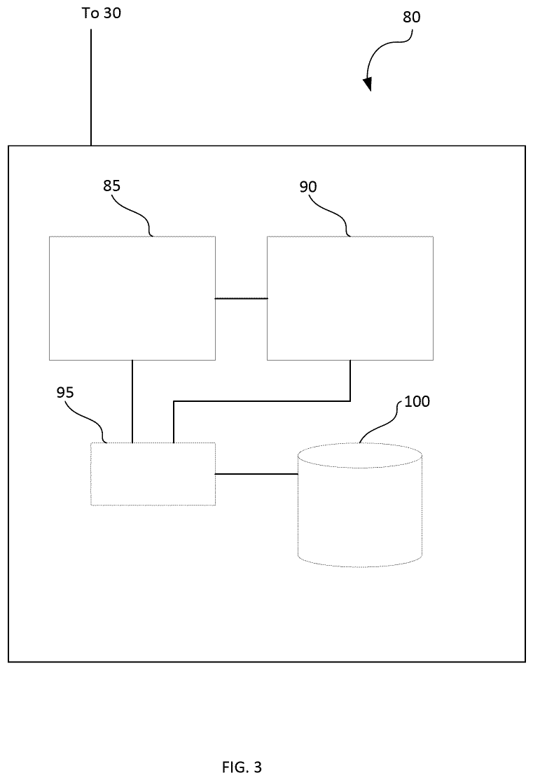

FIG. 3 illustrates a block diagram of the course assessment module 80 according to one embodiment. In this embodiment, the course assessment module 80 is operable to communicate with an instructor via, for example, the learning management system 10, the computing device 20, or the educational service provider system 30. In this embodiment, the course assessment module 80 includes an assessor management module 85 and an assessment management module 90. The course assessment module 80 may include its own processor 95 and memory storage/database 100 or may rely on those available through, for example, the educational service provider system 30 or otherwise.

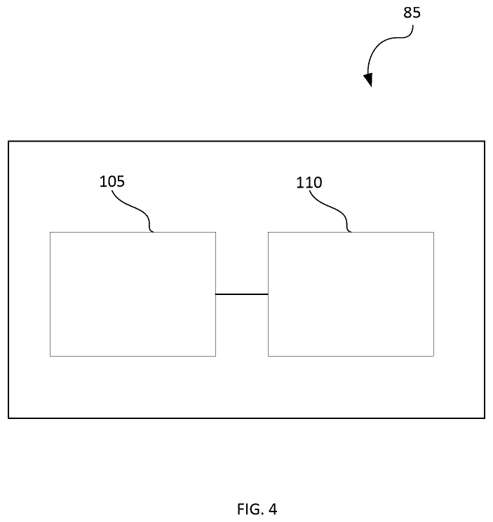

FIG. 4 illustrates the assessor management module 85, which includes an assessor selection module 105 and an assessor evaluation module 110. When an instructor is preparing for a course, the assessor management module 85 can be accessed to allow the instructor to search for, recruit and manage assessors. In particular, the accessor selection module 105 can include a list of available assessors or can include an automated system to recruit potential assessors, for example, post a notice seeking assessors and then allow input of various information by the recruited assessors. For example, the assessor selection module 105 may make use of social media sites to post assessor opportunities and may then have access to information on social media sites, metadata, cookies or the like to gather information on assessors and/or identify potential assessors to contact with notice of an opportunity. The information/data collected by the assessor management module 85 may be stored in, for example, the database 100. The database used for storage may be local, such as the database 100 of the assessor management module 85, or remote and accessed via, for example, the educational service provider system 30 or the like.

Generally speaking, the assessors may be considered internal (already connected with the learning management system) or external (found outside of the learning management system). These categories may include guest assessors or the like. The assessors can be selected based on expertise, knowledge of the course, average time to complete assessment after being assigned, previous performance in the same course, and any other factors that might be available in the information collected on each assessor. In the case of external assessors, the assessor management module 85 may also automatically manage login information and access permissions for assessors, particularly those that are selected. As an example, the system may provide an assessor with login access only to their assigned assessment information within the learning management system 10.

In any event, the instructor or the assessor management module 85 can review the list of accessors, including information available on the assessors and manually or automatically select accessors for the course, based on the available information. As the course progresses and/or after the course, the assessor evaluation module 110 allows for the evaluation of the assessors, for example, the instructor, or possibly students, may provide evaluations for the assessors. The assessor evaluation module 110 can also keep track of various metrics/statistics for each assessor, such as, Quality of Service (Qos) metrics, for example, time to complete assessments, number of assessments, assessment values per assignment such as average mark, spread of marks, or the like. The information/data received via the assessor evaluation module 110 can also be fed back into the assessor selection module 105 for review by instructors or the assessor management module 85 when selecting assessors for subsequent classes or the like. In some cases, the instructor or assessor management module 85 may select and assign assessors per assignment rather than per course or in some other way. In some cases, the assessor management module 85 may allow for delegate assessors to be picked by some or all selected assessors if the selected assessor can't complete an assignment or the like.

The assessment management module 90 allows the students in the class to be divided up for assignment to particular assessors. The dividing up of the students may be done by the instructor or may be done automatically by the assessment management module 90. In some cases, the assessment management module 90 may automatically assign students so that they are assessed by different assessors throughout the course to counter the fact that assessors can be somewhat different in their assessments. In some cases, the assessment management module 90 may assign some students to two or more assessors to analyze if there are differences between the assessors. In this case, the assessment management module 90 may also adjust student assessments based on these differences to provide a consistent assessment scheme. The assessment management module 90 can also include automated notification/nudging of assessors to notify assessors of dates for completion of the assessment in order to keep assessors meeting a required QoS target.

As an example of the operation of the course assessment module 80, the course assessment module 80 may receive an indication from an instructor that there is a need for assessors for a particular course. The assessor selection module 105 of the assessor management module 85 can then post a notice on a social media site seeking assessors, an assessor can select the notice for viewing and, when prompted, complete any needed information and/or allow access to the assessors' social media information for capture by the assessor selection module 105. For example, if a potential assessor is directed to the assessor management module 85/assessor selection module 105 by a social media site such as for example, Facebook™ or LinkedIn™, meta-data may be provided that will allow the assessor management module 85 to analyze potential assessor information (possibly by language-processing techniques on the user's social media site) to identify relevant background or qualifications of the potential assessor. For instance, if a potential assessor has previously already taken the course in question, then the assessor management module 85 may access the learning management system to determine the potential assessors mark in the same or similar course or other educational history to determine that the potential assessor may be a good fit.

The assessor management module 85 may then either automatically select assessors based on the available information or present the available information by a display for the instructor to use in reviewing the potential assessors. If selected automatically, the assessor management module 85 may use machine learning, artificial intelligence (AI) tools, or the like to make the selection (if there are excess potential assessors available).

Once the assessors are selected, each accessor will be assigned a set or subset of students to assess in the given course. As the assessor is working, the assessor evaluation module 110 will gather data relating to the assessor, for example statistical or direct feedback, and store that data together with the accessor information for future use. As noted above, the assessor may also receive notifications about assignments, due dates to be met, or the like during the course.

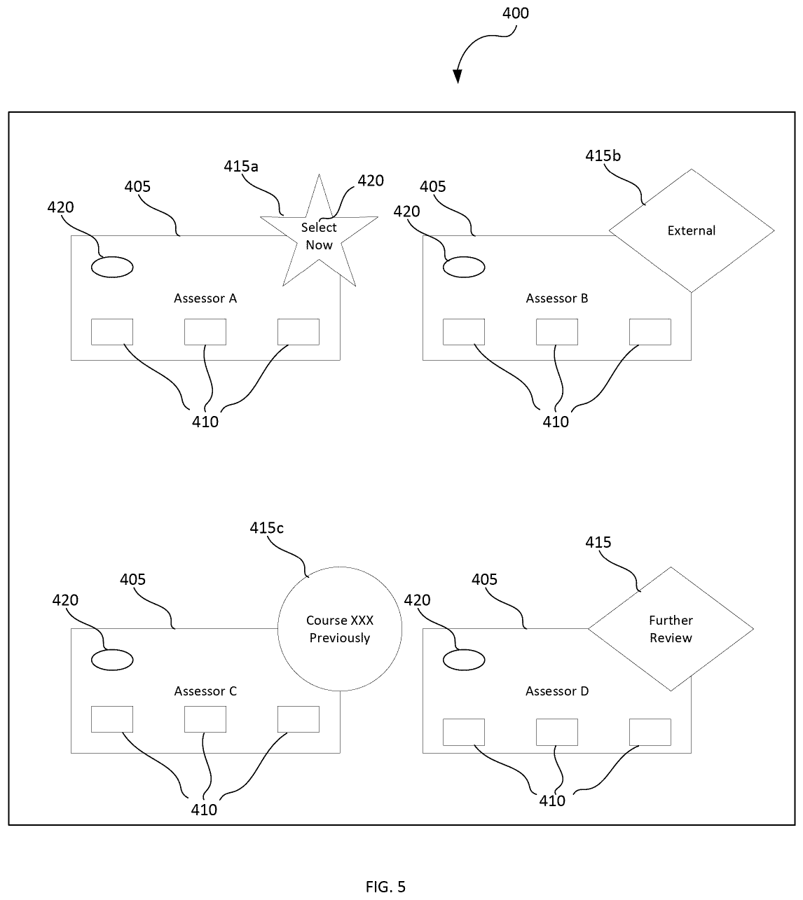

FIG. 5 illustrates an example assessor selection display for use by the instructor. As illustrated, assessors and assessors' information can be presented as a webpage displayed on a computing device, such as computing device 20, for example, via a browser or client software running on the computing device 20, or in any other suitable manner. As shown in this example, the various assessors 405 (which may include, for example, a photo of the potential assessor, a name of the assessor, an anonymized reference to an assessor, or the like) can be displayed and the assessor management module 85 can generate badges 415 associated with an assessor on the screen based on assessor information associated with each assessor. Each badge 415 may have a different shape, color, or other characteristic to differentiate each badge from another type of badge. In this particular example, a star badge 415a can indicate a “select now” link 420 or the like while a diamond badge 415b can indicate that an assessor is external and/or may need further review. In some cases, the diamond badge 415b can include a link that allows the instructor to initiate the process to seek further information from the potential assessor. As a further example, a circular badge 415c may include information, such as that an accessor has taken the course in question or the like. Other shapes, styles, colors, formats, and the like of badges can also be used.

As shown in FIG. 5, each displayed assessor may include links 410 to further information about the assessor. In some cases, this further information may be available by hovering over the assessor itself or a relevant link.

In some cases, the instructor may also have the ability to learn more about the assessor information provided in a badge 415 or the like. For example, the user may be able to mouse over a badge or access a hyperlink or the like to see further detail on the information in the badge 415. For example, the badge may provide further detail about the assessor's mark in the relevant course or other courses, the assessors previous timeliness, or the like.

Further, in some embodiments, an assessor 405 or a badge 415 may also include a handling link 420 to remove the assessor from future consideration, mark the assessor as a favorite, or the like. In this case, an instructor may be provided with options such as “save for future”, “don't show again” or the like.

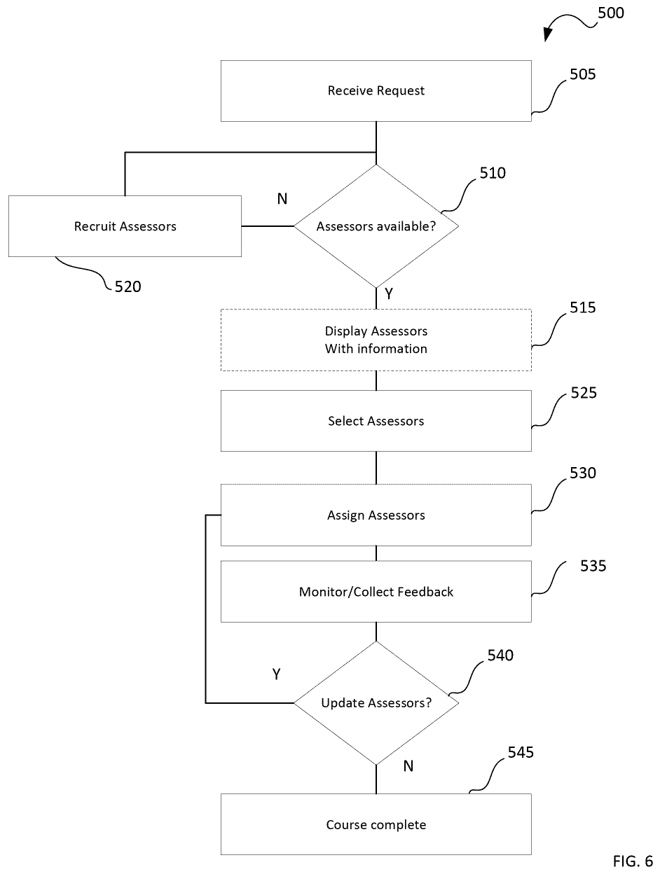

FIG. 6 is a flowchart illustrating a method 500 for assessment management according to an embodiment. The method 500 starts when the system (e.g. the course assessment module 80) receives, from an instructor, a request to manage assessors at 505. The system then determines if there are potential assessors available at 510. Determining if potential assessors are available may include already available potential assessors that have previously been registered. If there are, the system may then begin displaying available potential assessors at 515. If not, the system may conduct a recruitment drive at 520 to bring in potential assessors, as described above. This recruitment drive may be performed because the instructor requested additional assessors, if the number of available assessors is too low, or the like. If necessary, the system can continue to check the number of potential assessors and continue recruitment until an appropriate number of assessors are available or until all assessors are selected. As new assessors are added via the recruitment drive, the assessors may be added to the display. After the display of assessors at 515, the instructor selects assessors at 525. As noted above, some assessors may be pre-approved while others may need further information, which can be gathered either automatically or by follow up from the instructor or the like. Also as noted above, in some cases, the process of displaying assessors for instructor selection may not be needed if the system selects assessors itself, for example, if the number of assessors available matches the number needed or if the system otherwise selects assessors based on the information available. At 530, the assessors are assigned to a set or subset of students in the class. The assignment may be made by the instructor, automatically by the system, or the like. Once assigned, the system monitors and collects feedback on assessors at 535. Monitoring and collecting feedback can include metrics/statistics such as time to complete assessments, performance review feedback from the instructor/students, or the like. In some cases, the system can be configured to periodically update the assessors assigned to different subsets of students and this can be checked at 540. If yes, the assignment of assessors can be performed again at 530. If not, the system can wait for an indication that the course has ended at 545. It will be understood that feedback may also be received following the end of the course. Further, it will be understood that the updating of assessors may also involve the selection of new assessors, for example, if an assessor has had to drop out, is not performing acceptably, or the like.

In the preceding description, for purposes of explanation, numerous details are set forth in order to provide a thorough understanding of the embodiments. However, it will be apparent to one skilled in the art that these specific details may not be required. In other instances, structures may be shown in block diagram form in order not to obscure the understanding. For example, specific details are not provided as to whether the embodiments described herein are implemented as a software routine, hardware circuit, firmware, or a combination thereof.

Embodiments of the disclosure can be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with circuitry to perform the described tasks.

The above-described embodiments are intended to be examples only. Alterations, modifications and variations can be effected to the particular embodiments by those of skill in the art without departing from the scope, which is defined solely by the claims appended hereto.

What is claimed is:

1. A method for course assessment, the method comprising:
monitoring for a request to select assessors for a course by an instructor;
upon receipt of a request, preparing a list of potential assessors and determining if additional potential assessors are required,
if so:
automatically posting a request for potential assessors; and
receiving information about potential assessors; and
updating the list of potential assessors;
if not: proceeding;
selecting assessors for the course from the list of potential assessors;
assigning the select assessors to a set of students in the course, and
monitoring the assigned assessors during and after the course.

2. A method according to claim 1, further comprising, prior to selecting assessors, displaying the list of potential assessors to the instructor.

3. A method according to claim 2, wherein the displaying the list of potential assessors comprises presenting one or more informational elements for each assessor.

4. A method according to claim 3, wherein the one or more informational elements for each assessor comprises, if available, past evaluations for each assessor.

5. A method according to claim 2, wherein the displaying the list of potential assessors comprises:
presenting a first informational element for assessors that are already approved; and
presenting a second informational element for assessors that require additional information before registration.

6. A method according to claim 1, wherein the assigning the select assessors to the course comprises at least one of:
sending a communication to the accessor notifying of the assignment; and
providing login information to the assessor.

7. A method according to claim 1, wherein the assigning the select assessors to a set of students in the course further comprises:
updating the assignment of the assessors to a different set of students during the course.

8. A method according to claim 1, wherein the monitoring the assigned assessors comprises:
collecting evaluations for the assigned assessors; and
storing the collected evaluations in association with the assigned assessors.

9. A method according to claim 1, wherein the determining if additional potential assessors are required comprises:
determining if the instructor has requested additional instructors, and
if not, determining if there are sufficient assessors on the list of potential assessors.

10. A system for course assessment, the system comprising:
a processor;
a memory storing computer-readable instructions, which, when executed on the processor, generate the following:
an assessor management module configured to:
monitor for a request to select assessors for a course by an instructor;
upon receipt of a request, preparing a list of potential assessors and determine if additional potential assessors are required,
if so:
automatically posting a request for potential assessors;
and
receiving information about potential assessors; and
updating the list of potential assessors;
if not: proceeding;
select assessors for the course from the list of potential assessors; and
an assessment management module configured to:
assign the select assessors to a set of students in the course, and
monitor the assigned assessors during and after the course.

11. A system according to claim 10, wherein the assessor management module, prior to the select assessors, displays the list of potential assessors to the instructor.

12. A system according to claim 11, wherein the displaying the list of potential assessors comprises presenting one or more informational elements for each assessor.

13. A system according to claim 12, wherein the one or more informational elements for each assessor comprises, if available, past evaluations for each assessor.

14. A system according to claim 11, wherein the displaying the list of potential assessors comprises:
presenting a first informational element for assessors that are already approved; and
presenting a second informational element for assessors that require additional information before registration.

15. A system according to claim 10, wherein the assign the select assessors comprises at least one of:
sending a communication to the accessor notifying of the assignment; and
providing login information to the assessor.

16. A system according to claim 10, wherein the assign the select assessors further comprises:
updating the assignment of the assessors to a different set of students during the course.

17. A system according to claim 10, wherein the monitor the assigned assessors comprises:
collecting evaluations for the assigned assessors; and
storing the collected evaluations in association with the assigned assessors.

18. A system according to claim 10, wherein the determine if additional potential assessors are required comprises:
determining if the instructor has requested additional instructors, and
if not, determining if there are sufficient assessors on the list of potential assessors.
